(19) United States
(12) Patent Application Publication
(10) Pub. No.: US 2020/0254687 A1
(43) Pub. Date: Aug. 13, 2020

(54) THREE-DIMENSIONAL SHAPING APPARATUS, CONTROL METHOD OF THREE-DIMENSIONAL SHAPING APPARATUS, AND CONTROL PROGRAM OF THREE-DIMENSIONAL SHAPING APPARATUS

(71) Applicant: KANTATSU CO., LTD., Yaita-shi (JP)

(72) Inventor: Eiji OSHIMA, Yaita-shi (JP)

(21) Appl. No.: 16/665,498

(22) Filed: Oct. 28, 2019

(30) Foreign Application Priority Data
Oct. 26, 2018 (JP) 2018-201380

(51) Int. Cl. B29C 64/268; B29C 64/282; B29C 64/393

(52) U.S. Cl. CPC B29C 64/268; B33Y 30/00; B29C 64/393; B29C 64/282

(57) ABSTRACT

A reproduction is manufactured simply and quickly. A three-dimensional shaping apparatus includes a light irradiator that performs irradiation with different kinds of a first laser beam and a second laser beam, a light receiver that receives reflected light of the first laser beam with which an object is irradiated from the light irradiator, a measurer that measures a shape of the object based on the reflected light, and a controller that shapes a three-dimensional shaped object by controlling irradiation of a material of the three-dimensional shaped object with the second laser beam by the light irradiator based on the shape of the object measured by the measurer.

### BACKGROUND OF THE INVENTION

### Field of the Invention

The present invention relates to a three-dimensional shaping apparatus, a control method of the three-dimensional shaping apparatus, and a control program of the three-dimensional shaping apparatus.

### Description of the Related Art

In the above technical field, patent literature 1 discloses a technique of receiving reflected light of exposure light by a CCD camera and adjusting a focus position.

[Patent Literature 1] Japanese Patent Laid-Open No. 2006-240045

### SUMMARY OF THE INVENTION

In the technique described in the above literature, however, it is impossible to shape a reproduction simply and quickly.

The present invention provides a technique of solving the above-described problem.

One example aspect of the present invention provides a three-dimensional shaping apparatus comprising:

a light irradiator that performs irradiation with different kinds of a first laser beam and a second laser beam;

a light receiver that receives reflected light of the first laser beam with which an object is irradiated from the light irradiator;

a measurer that measures a shape of the object based on the reflected light; and

a controller that shapes a three-dimensional shaped object by controlling irradiation of a material of the three-dimensional shaped object with the second laser beam by the light irradiator based on the shape of the object measured by the measurer.

Another example aspect of the present invention provides a control method of a three-dimensional shaping apparatus, comprising:

performing irradiation with different kinds of a first laser beam and a second laser beam;

receiving reflected light of the first laser beam with which an object is irradiated in the performing the irradiation;

measuring a shape of the object based on the reflected light; and

shaping a three-dimensional shaped object by controlling irradiation of a material of the three-dimensional shaped object with the second laser beam in the performing the irradiation based on the shape of the object measured in the measuring.

Still other example aspect of the present invention provides a control program of a three-dimensional shaping apparatus for causing a computer to execute a method, comprising:

performing irradiation with different kinds of a first laser beam and a second laser beam;

receiving reflected light of the first laser beam with which an object is irradiated in the performing the irradiation;

measuring a shape of the object based on the reflected light; and

shaping a three-dimensional shaped object by controlling irradiation of a material of the three-dimensional shaped object with the second laser beam in the performing the irradiation based on the shape of the object measured in the measuring.

According to the present invention, it is possible to shape a reproduction simply and quickly.

### BRIEF DESCRIPTION OF THE DRAWINGS

FIG. 1A is a view showing the arrangement of a three-dimensional shaping apparatus according to the first example embodiment of the present invention;

FIG. 1B is a view showing the arrangement of the three-dimensional shaping apparatus according to the first example embodiment of the present invention;

FIG. 2 is a view for explaining the arrangement of a three-dimensional shaping apparatus according to the second example embodiment of the present invention;

FIG. 3A is a view for explaining the arrangement of a light irradiator of the three-dimensional shaping apparatus according to the second example embodiment of the present invention;

FIG. 3B is a view for explaining an example of shape measurement and shaping by the three-dimensional shaping apparatus according to the second example embodiment of the present invention;

FIG. 4 is a table showing an example of a shaping table provided in the three-dimensional shaping apparatus according to the second example embodiment of the present invention;

FIG. 5 is a block diagram for explaining the hardware arrangement of the three-dimensional shaping apparatus according to the second example embodiment of the present invention;

FIG. 6 is a flowchart for explaining the operation procedure of the three-dimensional shaping apparatus according to the second example embodiment of the present invention;

FIG. 7 is a view for explaining an example of shape measurement by a three-dimensional shaping apparatus according to the third example embodiment of the present invention;

FIG. 8 is a view for explaining an example of shape measurement by a three-dimensional shaping apparatus according to the fourth example embodiment of the present invention;

FIG. 9A is a view for explaining an example of shape measurement by a three-dimensional shaping apparatus according to the fifth example embodiment of the present invention; and

FIG. 9B is a view for explaining an example of shaping by the three-dimensional shaping apparatus according to the fifth example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

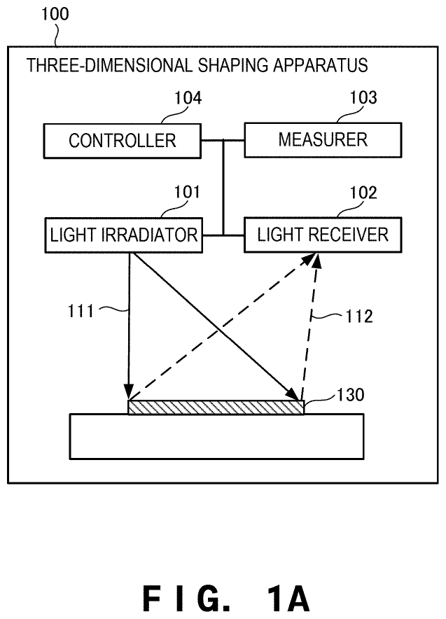

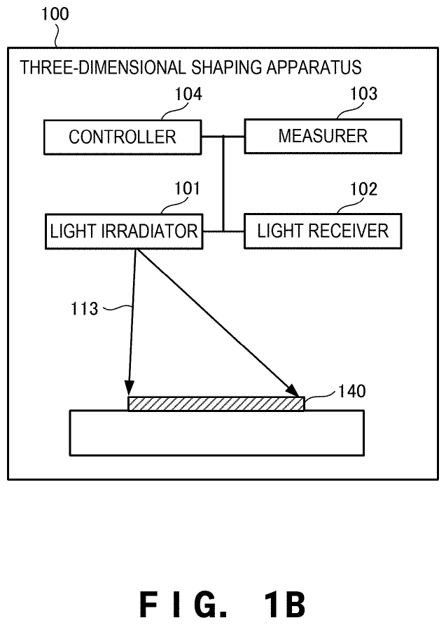

A three-dimensional shaping apparatus 100 according to the first example embodiment of the present invention will be described with reference to FIGS. 1A and 1B. The three-dimensional shaping apparatus 100 is a shaping apparatus that shapes a reproduction. As shown in FIGS. 1A and 1B, the three-dimensional shaping apparatus 100 includes a light irradiator 101, a light receiver 102, a measurer 103, and a controller 104.

The light irradiator 101 performs irradiation with different kinds of a first laser beam 111 and a second laser beam 113. The light receiver 102 receives reflected light 112 of the first laser beam 111 with which an object 130 is irradiated from the light irradiator 101. The measurer 103 measures the shape of the object 130 based on the reflected light 112. The controller 104 controls irradiation of the material of a three-dimensional shaped object 140 with the second laser beam 113 by the light irradiator 101 based on the shape of the object 130 measured by the measurer 103, thereby shaping the three-dimensional shaped object 140.

According to this example embodiment, it is possible to shape a reproduction simply and quickly.

### Second Example Embodiment

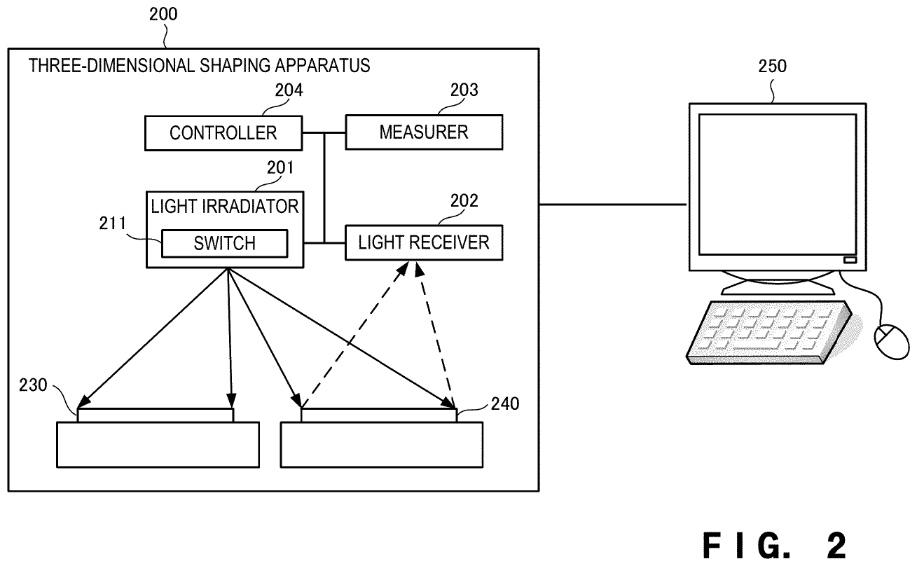

A three-dimensional shaping apparatus according to the second example embodiment of the present invention will be described next with reference to FIGS. 2 to 6. FIG. 2 is a view for explaining the arrangement of the three-dimensional shaping apparatus according to this example embodiment. A three-dimensional shaping apparatus 200 includes a light irradiator 201, a light receiver 202, a measurer 203, and a controller 204. The light irradiator 201 includes a switch 211.

The light irradiator 201 irradiates the material of a three-dimensional shaped object 230 and an object 240 with laser beams, respectively. The laser beam with which the material of the three-dimensional shaped object 230 is irradiated is a laser beam for shaping. The laser beam with which the object 240 is irradiated is a visible laser beam or an infrared laser beam. The switch 211 switches between these laser beams (laser beam for shaping, visible laser beam, and infrared laser beam) appropriately. Note that the object 240 is, for example, a three-dimensional shaped object, a three-dimensional object formed by injection shaping, or a three-dimensional object formed by mold shaping, but is not limited to them.

The light receiver 202 receives reflected light 241 from the object 240. If the light irradiator 201 irradiates the object 240 with the infrared laser beam, the light receiver 202 serves as a light receiving element (light receiving sensor) capable of receiving the infrared laser beam. If the light irradiator 201 irradiates the object 240 with the visible laser beam, the light receiver 202 serves as a light receiving element (light receiving sensor) capable of receiving the visible laser beam. Examples of the light receiving elements are a photo detector, a photo diode, a CCD (Charged Coupled Devices) sensor, and a CMOS (Complementary Meta-Oxide-Semiconductor) sensor, but are not limited to them.

The measurer 203 measures the shape of the object 240 based on the reflected light 241 received by the light receiver 202. Measurement of the shape by the measurer 203 is implemented by, for example, measuring a distance to each point on the surface of the object 240. Measurement of the distance by the measurer 203 is implemented by, for example, the TOF (Time of Flight) method, the trigonometry method, the phase difference method (phase shift method), or the like. Measurement of the distance can appropriately be selected in accordance with the feature of each method. The measurer 203 measures the shape of the object 240 based on the distances to the respective points on the surface of the object 240. The measurer 203 generates data of the measured shape.

The controller 204 (memory) controls irradiation of the material of the three-dimensional shaped object 230 with the laser beam for shaping by the light irradiator 201 based on the shape of the object 240 measured by the measurer 203. That is, since the controller 204 controls the light irradiator 201, that emits the visible laser beam or the infrared laser beam to measure the shape of the object 240, to switch the emitted laser beam to the laser beam for shaping in order to shape the three-dimensional shaped object 230, thereby performing irradiation. This irradiates the material of the three-dimensional shaped object 230 with the laser beam for shaping, thereby shaping the three-dimensional shaped object 230.

The three-dimensional shaping apparatus 200 performs measurement of the shape of the object 240 and shaping of the three-dimensional shaped object 230 at almost the same time. For example, after performing a scan for measurement of the shape of the object 240 a predetermined number of times, the three-dimensional shaping apparatus 200 shapes the three-dimensional shaped object 230 based on measurement data for the predetermined number of times. Alternatively, the three-dimensional shaping apparatus 200 may shape the three-dimensional shaped object 230 every time the object 240 is scanned once.

The operator of the three-dimensional shaping apparatus 200 operates the three-dimensional shaping apparatus 200 using an operation computer 250. The shape of the object 240 measured by the three-dimensional shaping apparatus 200 is displayed on, for example, a display device such as the monitor of the operation computer 250. Shaping data for shaping the three-dimensional shaped object 230 or the like is created by CAD (Computer Aided Design) installed in the operation computer 250 or the like.

Then, upon receiving the shaping data from the operation computer 250, the three-dimensional shaping apparatus 200 executes shaping of the three-dimensional shaped object 230 based on the received shaping data. Note that creation of the shaping data or the like is not limited to creation using the CAD, and may be, for example, creation using CAE (Computer Aided Engineering), an application of a smartphone, or the like.

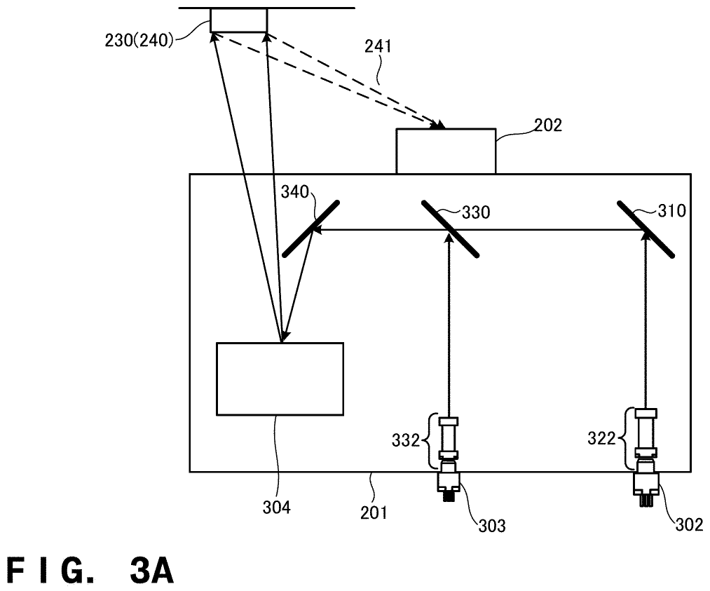

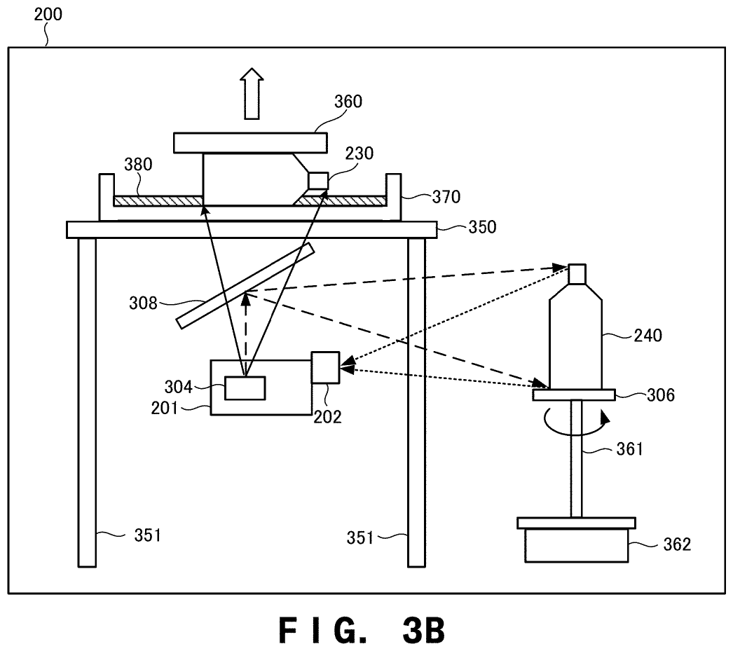

FIG. 3A is a view for explaining the arrangement of the light irradiator of the three-dimensional shaping apparatus according to this example embodiment. The light irradiator 201 includes a laser source 302 and a two-dimensional MEMS (Micro Electro Mechanical System) mirror 304. The two-dimensional MEMS mirror 304 is an electromechanical mirror.

The laser source 302 is a source of a laser beam having a wavelength of 405 nm. The wavelength of the laser beam emitted from the laser source 302 is not limited to 405 nm, and a laser beam in the wavelength region of UV light may be emitted. The laser beam emitted from the laser source 302 is used to shape the three-dimensional shaped object 230. Then, the laser beam emitted from the laser source 302 is guided to a condenser 322. The condenser 322 includes a condenser lens and a collimator lens. The laser source 302 is a semiconductor LD (Laser Diode), and is a laser beam oscillation element that emits (oscillates) a laser beam or the like. For example, the visible laser beam entering the condenser 322 is condensed by the condenser lens, is collimated by the collimator lens, and is then emitted.

A laser source 303 is a source of a visible laser beam or an infrared laser beam. The laser beam emitted from the laser source 303 is guided to a condenser 332. The condenser 332 includes a condenser lens and a collimator lens. The laser source 303 is a semiconductor LD (Laser Diode), and is a laser beam oscillation element that emits (oscillates) a laser beam. For example, the laser beam entering the condenser 332 is condensed by the condenser lens, is collimated by the collimator lens, and is then emitted. When performing shape measurement by irradiating the object 240 with the infrared laser beam, the infrared laser beam is scanned on the object 240. When performing shape measurement by irradiating the object 240 with the visible laser beam, the object 240 is irradiated with, for example, a latticed pattern (stripe pattern).

The two-dimensional MEMS mirror 304 is an electromechanical mirror. The two-dimensional MEMS mirror 304 is a driving mirror that is driven based on a control signal input from the outside, and vibrates to reflect the laser beam while changing the angle in the horizontal direction (X direction) and the vertical direction (Y direction). The laser beam reflected by the two-dimensional MEMS mirror 304 is corrected by a view angle correction element (not shown) in terms of a view angle. Then, the laser beam which has been corrected in terms of the view angle is scanned on the three-dimensional shaped object 230, the object 240, or a process surface, thereby performing desired processing or shaping. Note that the view angle correction element is installed, as needed. Note that two one-dimensional MEMS mirrors may be used, instead of using the two-dimensional MEMS mirror 304.

The visible laser beam emitted from the light source 302 is reflected by mirrors 310 and 340 to reach the two-dimensional MEMS mirror 304. The infrared laser beam emitted from the light source 303 is reflected by a mirror 330 and the mirror 340 to reach the two-dimensional MEMS mirror 304. The mirror 340 is arranged in a bottom portion (bottom surface) of the light irradiator 201. The mirror 310 reflects the reflected light of the visible laser beam from the laser source 302 downward to the mirror 340 arranged on the bottom surface. Similarly, the mirror 330 reflects the reflected light of the infrared laser beam from the light source 303 downward to the mirror 340 arranged on the bottom surface. The mirror 340 reflects each of the visible laser beam from the mirror 310 and the infrared laser beam from the mirror 330 upward to the two-dimensional MEMS mirror 304 arranged above the mirror 340. The two-dimensional MEMS mirror 304 scans the reflected light from the mirror 340 in the two-dimensional directions to perform irradiation.

Each of the visible laser beam emitted from the laser source 302 and the infrared laser beam emitted from the laser source 303 is reflected by the mirror 310 or 330 and the mirror 340, and then passes through the two-dimensional MEMS mirror 304, thereby reaching the object 240. That is, the laser beam for processing, the visible laser beam, and the infrared laser beam pass through the same optical path (one optical path) to reach the material of the three-dimensional shaped object 230 and the object 240.

FIG. 3B is a view for explaining an example of shape measurement and shaping by the three-dimensional shaping apparatus according to this example embodiment. The three-dimensional shaping apparatus 200 includes the light irradiator 201, a shaping table 350, an attachment 306, and a reflecting mirror 308.

The object 240 as a shape measurement target is placed on the attachment 306. Then, the attachment 306 is connected to a rotating shaft 361. The rotating shaft 361 is connected to a rotating mechanism 362. Along with the rotation of the rotating mechanism 362, the rotating shaft 361 rotates. Along with the rotation of the rotating shaft 361, the attachment 306 rotates, and thus the object 240 placed on the attachment 306 also rotates.

The reflecting mirror 308 is arranged between the light irradiator 201 and the shaping table 350. The visible laser beam or the infrared laser beam from the light irradiator 201 is reflected by the reflecting mirror 308 to irradiate the object 240 placed on the attachment 306.

The light irradiator 201 irradiates the rotating object 240 with the infrared laser beam or the visible laser beam, and the light receiver 202 receives the reflected light of the infrared laser beam or the visible laser beam. The measurer 203 measures the shape of the object 240 based on the received reflected light.

Note that legs 351 that support the shaping table 350 are provided in the shaping table 350. The legs 351 are provided at the four corners of the shaping table 350 not to obstruct the light beam path of the visible laser beam or the infrared laser beam reflected by the reflecting mirror 308 or the light beam path of the reflected light from the object 240.

The controller 204 controls irradiation of the material of the three-dimensional shaped object 230 with the laser beam for processing by the light irradiator 201 based on the shape of the object 240 measured by the measurer 203, thereby shaping the three-dimensional shaped object 230. That is, while raising a platform 360, a resin 380 as the material of the three-dimensional shaped object 230 filled in a vat 370 placed on the shaping table 350 is irradiated with the laser beam for processing, thereby shaping the three-dimensional shaped object 230. The resin 380 is, for example, a photo-curing resin that is cured when it is irradiated with the laser beam for processing. Note that the reflecting mirror 308 is a mirror that can transmit the laser beam for processing from the light irradiator 201.

The three-dimensional shaping apparatus 200 performs measurement of the shape of the object 240 and shaping of the three-dimensional shaped object 230 at almost the same time. That is, the three-dimensional shaping apparatus 200 does not shape the three-dimensional shaped object after completion of measurement of the overall shape of the object 240. For example, upon completion of measurement (scan) of the shape for a predetermined height of the object 240, the three-dimensional shaping apparatus 200 shapes the three-dimensional shaped object 230 based on the measurement data. This can perform measurement of the shape of the object 240 and shaping of the three-dimensional shaped object 230 at almost the same time. Alternatively, the three-dimensional shaping apparatus 200 may shape the three-dimensional shaped object 230 every time one scan of the object 240, for example, a scan during one rotation of the object 240 ends. That is, a scan (shape measurement) of the object 240 and shaping of the three-dimensional shaped object 230 may alternately be performed.

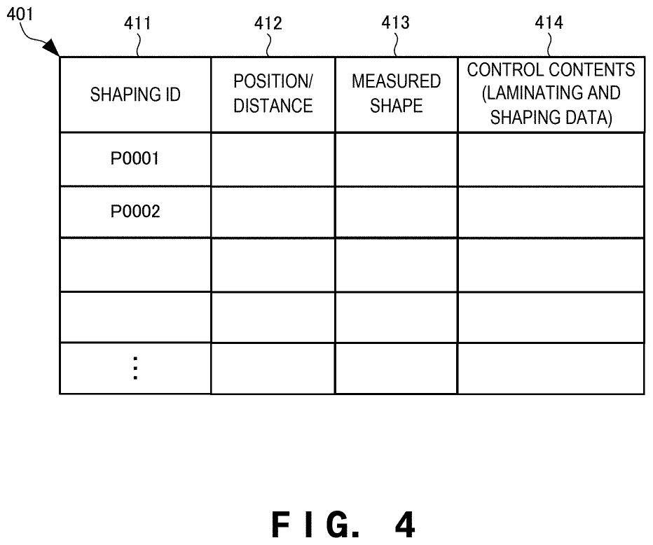

FIG. 4 is a table showing an example of a shaping table provided in the three-dimensional shaping apparatus according to this example embodiment. A shaping table 401 stores a position/distance 412, a measured shape 413, and control contents (laminating and shaping data) 414 in association with a shaping ID (IDentifier) 411. The shaping ID 411 is an identifier for identifying shaping in the three-dimensional shaping apparatus 200. The position/distance 412 indicates a distance from each point (position) on the surface of the object 240 derived based on the reflected light received by the light receiver 202. The measured shape 413 is the measured shape of the object 240. The control contents 414 indicate contents of control of the light irradiator 201 and the like in shaping of the three-dimensional shaped object 230 executed based on the measured shape of the object 240. Then, the three-dimensional shaping apparatus 200 shapes the three-dimensional shaped object with reference to, for example, the shaping table 401.

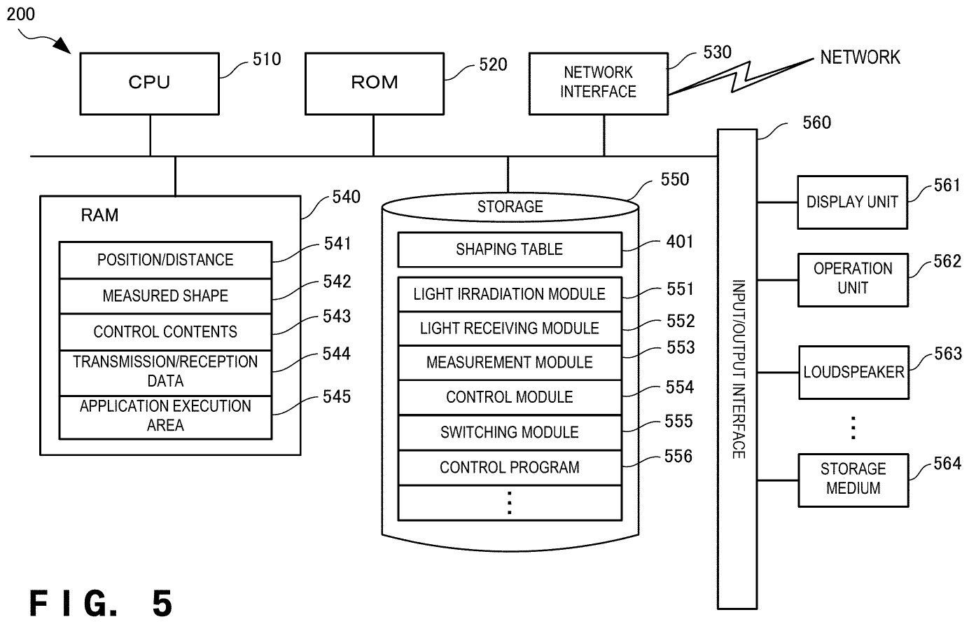

FIG. 5 is a block diagram showing the hardware arrangement of the three-dimensional shaping apparatus according to this example embodiment. A CPU (Central Processing Unit) 510 is an arithmetic control processor, and implements the functional components of the three-dimensional shaping apparatus 200 shown in FIG. 2 by executing a program. The CPU 510 may include a plurality of processors to parallelly execute different programs, modules, tasks, or threads. A ROM (Read Only Memory) 520 stores permanent data such as initial data and a program, and other programs. A network interface 530 communicates with another apparatus via a network. Note that the number of CPUs 510 is not limited to one, and a plurality of CPUs or a GPU (Graphics Processing Unit) for image processing may be included. The network interface 530 desirably includes a CPU independent of the CPU 510, and writes or reads out transmission/reception data in or from the area of a RAM (Random Access Memory) 540. It is desirable to provide a DMAC (Direct Memory Access Controller) (not shown) for transferring data between the RAM 540 and a storage 550. Furthermore, the CPU 510 processes the data by recognizing that the data has been received by or transferred to the RAM 540. The CPU 510 prepares a processing result in the RAM 540, and delegates succeeding transmission or transfer to the network interface 530 or DMAC.

The RAM 540 is a random access memory used as a temporary storage work area by the CPU 510. An area to store data necessary for implementation of this example embodiment is allocated to the RAM 540. A position/distance 541 indicates a distance from each point on the surface of the object 240. A measured shape 542 indicates the measured shape of the object 240. Control contents 543 indicate data of contents of control of the light irradiator 201 and the like in shaping of the three-dimensional shaped object 230 executed based on the measured shape of the object 240. These data are deployed from, for example, the shaping table 401.

Transmission/reception data 544 is data transmitted/received via the network interface 530. The RAM 540 includes an application execution area 545 for executing various application modules.

The storage 550 stores a database, various parameters, or the following data or programs necessary for implementation of this example embodiment. The storage 550 stores the shaping table 401. The shaping table 401 is the table, shown in FIG. 4, for managing the relationship between the shaping ID 411 and the control contents 414 and the like.

The storage 550 also stores a light irradiation module 551, a light receiving module 552, a measurement module 553, a control module 554, and a switching module 555. The light irradiation module 551 is a module that irradiates the material of the three-dimensional shaped object 230 and the object 240 with laser beams. The light receiving module 552 is a module that receives reflected light from the object 240. The measurement module 553 is a module that measures the shape of the object 240 based on the received reflected light. The control module 554 is a module that controls irradiation of the material of the three-dimensional shaped object 230 with the laser beam by the light irradiator 201 and the like based on the measured shape of the object 240. The switching module 555 is a module that switches the laser beam (visible laser beam, infrared laser beam, and laser beam for shaping) to be emitted from the light irradiator 201. These modules 551 to 555 are read out by the CPU 510 into the application execution area 545 of the RAM 540, and executed. A control program 556 is a program for controlling the whole three-dimensional shaping apparatus 200.

An input/output interface 560 interfaces input/output data with an input/output device. The input/output interface 560 is connected to a display unit 561 and an operation unit 562. In addition, a storage medium 564 may be connected to the input/output interface 560. A loudspeaker 563 serving as a voice output unit, a microphone (not shown) serving as a voice input unit, or a GPS position determiner may also be connected. Note that programs and data which are associated with the general-purpose functions of the three-dimensional shaping apparatus 200 and other feasible functions are not shown in the RAM 540 or the storage 550 of FIG. 5.

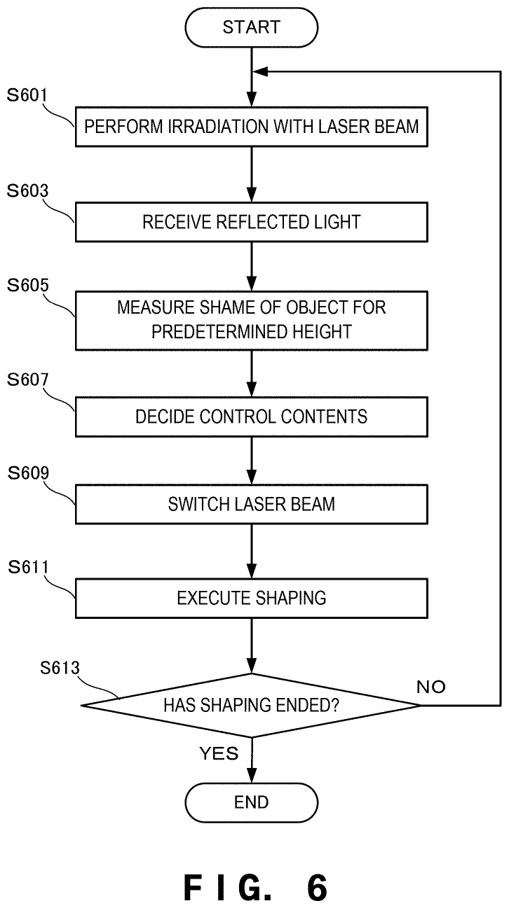

FIG. 6 is a flowchart for explaining the processing procedure of the three-dimensional shaping apparatus according to this example embodiment. This flowchart is executed by the CPU 510 of FIG. 5 using the RAM 540, thereby implementing the functional components of the three-dimensional shaping apparatus 200 shown in FIG. 2.

In step S601, the three-dimensional shaping apparatus 200 irradiates the object 240 with the visible laser beam or the infrared laser beam. In step S603, the three-dimensional shaping apparatus 200 receives reflected light from the object 240. In step S605, the three-dimensional shaping apparatus 200 measures the shape of the object 240 for a predetermined height. In step S607, the three-dimensional shaping apparatus 200 decides, based on the measured shape of the object 240, contents of control of irradiation of the material of the three-dimensional shaped object 230 with the laser beam for processing by the light irradiator 201. In step S609, the three-dimensional shaping apparatus 200 switches, from the infrared laser beam (visible laser beam) to the laser beam for processing, the laser beam to be emitted from the light irradiator 201. In step S611, the three-dimensional shaping apparatus 200 executes shaping of the three-dimensional shaped object 230. In step S613, the three-dimensional shaping apparatus 200 determines whether the shaping has ended. If it is determined that the shaping has not ended (NO in step S613), the three-dimensional shaping apparatus 200 returns to step S601 to continue the shaping; otherwise (YES in step S613), the three-dimensional shaping apparatus 200 ends the shaping processing.

According to this example embodiment, since measurement of the shape of an object and shaping of a three-dimensional shaped object are performed at almost the same time, it is possible to shape a desired three-dimensional shaped object simply, quickly, and accurately.

### Third Example Embodiment

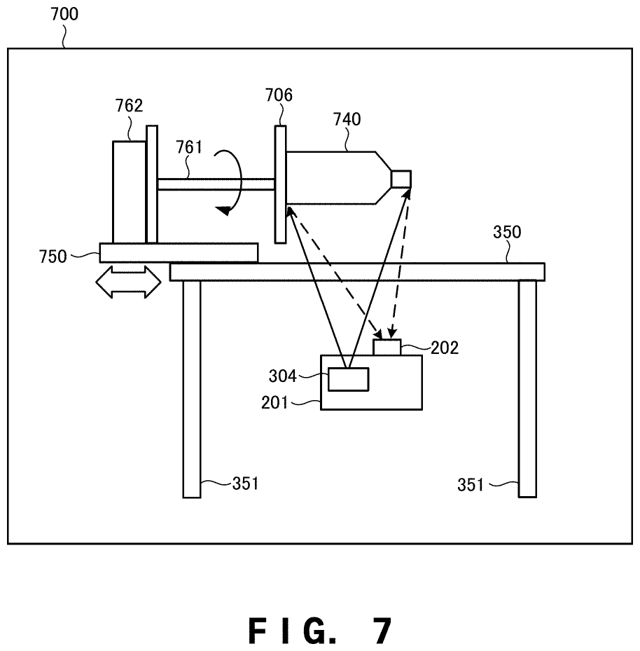

A three-dimensional shaping apparatus according to the third example embodiment of the present invention will be described next with reference to FIG. 7. FIG. 7 is a view for explaining an example of shape measurement by the three-dimensional shaping apparatus according to this example embodiment. The three-dimensional shaping apparatus according to this example embodiment is different from that in the above-described second example embodiment in that an attachment for attaching an object as a measurement target is provided. The remaining components and operations are the same as those in the second example embodiment. Hence, the same reference numerals denote the same components and operations, and a detailed description thereof will be omitted.

An object 740 as a shape measurement target is attached to an attachment 706. The attachment 706 is connected to a rotating shaft 761. The rotating shaft 761 is connected to a rotating mechanism 762. The object 740 attached to the attachment 706 rotates along with the rotation of the rotating shaft 761. While rotating the object 740 attached to the attachment 706, the shape of the object 740 is measured by irradiating the object 740 with an infrared laser beam or a visible laser beam. The attachment 706 is also attached to a predetermined base 750. The base 750 moves so that the object 740 is located at a position above a light irradiator 201 during measurement of the shape of the object 740. After the measurement of the shape of the object 740 ends, the base 750 moves to retract the object 740 from the position above the light irradiator 201. Note that a three-dimensional shaping apparatus 700 executes shaping of a three-dimensional shaped object after completion of the measurement of the shape of the object 740.

According to this example embodiment, since it is possible to measure a shape while rotating an object, the accurate shape of the object can be measured.

### Fourth Example Embodiment

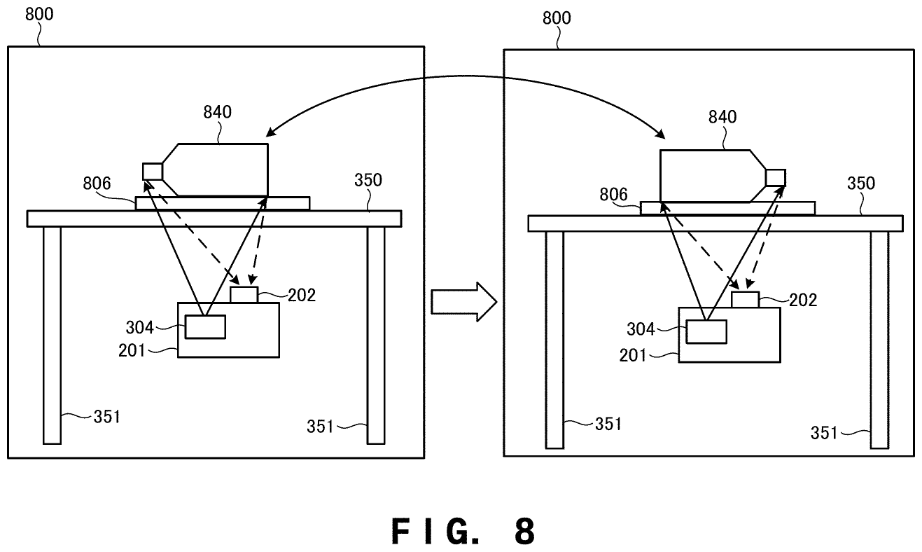

A three-dimensional shaping apparatus according to the fourth example embodiment of the present invention will be described next with reference to FIG. 8. FIG. 8 is a view for explaining an example of shape measurement by the three-dimensional shaping apparatus according to this example embodiment. The three-dimensional shaping apparatus according to this example embodiment is different from that in the above-described third example embodiment in that an attachment is provided without including a rotating mechanism. The remaining components and operations are the same as those in the third example embodiment. Hence, the same reference numerals denote the same components and operations, and a detailed description thereof will be omitted.

FIG. 8 is a view for explaining an example of shape measurement by the three-dimensional shaping apparatus according to this example embodiment. As shown in FIG. 8, an object 840 as a shape measurement target is placed on an attachment 806, and is irradiated with an infrared laser beam or a visible laser beam, thereby performing shape measurement (the left view of FIG. 8). The attachment 806 is arranged at a position above a light irradiator 201. In this case, since the attachment 806 cannot be rotated unlike FIG. 7, the orientation of the object 840 on the attachment 806 is changed to perform shape measurement (the right view of FIG. 8). If there are shape measurement data from at least two directions, it is possible to measure the shape of the object 840. After the measurement of the shape of the object 840 ends, the attachment 806 is retracted from the position above the light irradiator 201, and a three-dimensional shaped object is then shaped. Note that the attachment 806 is a member capable of transmitting the infrared laser beam or the visible laser beam. A three-dimensional shaping apparatus 800 executes shaping of the three-dimensional shaped object after completion of the measurement of the shape of the object 840.

According to this example embodiment, since it is possible to perform shape measurement in a small number of steps, the time taken to shape a three-dimensional shaped object can be shortened. In addition, it is unnecessary to provide a rotating mechanism and the like, it is possible to adopt a simple apparatus arrangement.

### Fifth Example Embodiment

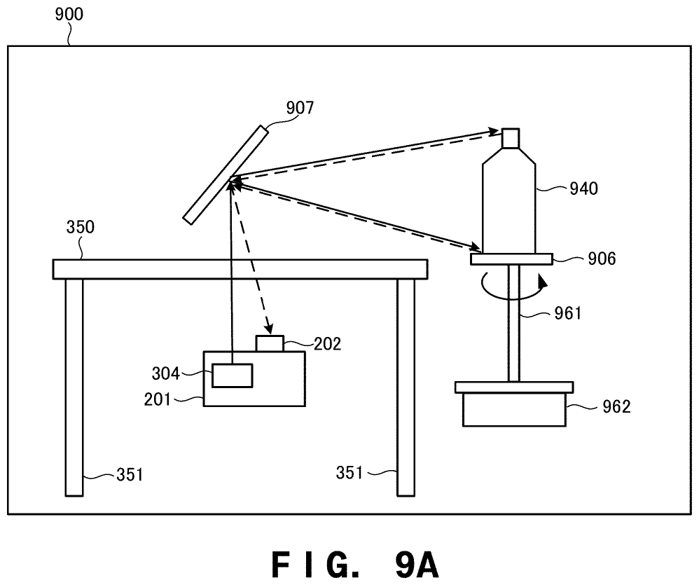

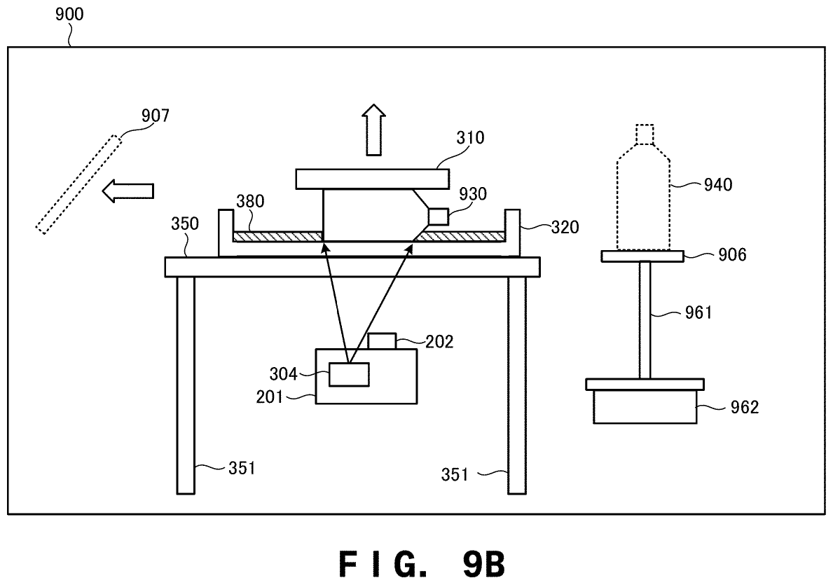

A three-dimensional shaping apparatus according to the fifth example embodiment of the present invention will be described next with reference to FIGS. 9A and 9B. FIG. 9A is a view for explaining an example of shape measurement by the three-dimensional shaping apparatus according to this example embodiment. FIG. 9B is a view for explaining an example of shaping by the three-dimensional shaping apparatus according to this example embodiment. The three-dimensional shaping apparatus according to this example embodiment is different from those in the above-described second to fourth example embodiments in that a reflecting mirror is provided. The remaining components and operations are the same as those in the second to fourth example embodiments. Hence, the same reference numerals denote the same components and operations, and a detailed description thereof will be omitted.

As shown in FIG. 9A, a three-dimensional shaping apparatus 900 includes a reflecting mirror 907. The three-dimensional shaping apparatus 900 causes the reflecting mirror 907 to reflect an infrared laser beam or a visible laser beam exiting from a two-dimensional MEMS mirror 304 to irradiate an object 940 as a shape measurement target. The object 940 is placed on an attachment 906. The attachment 906 is connected to a rotating shaft 961, and the rotating shaft 961 is connected to a rotating mechanism 962. While rotating the attachment 906, the shape of the object 940 is measured. After the measurement of the shape of the object 940 ends, the reflecting mirror 907 is moved, as shown in FIG. 9B. Note that the object 940 may be extracted from the three-dimensional shaping apparatus 900 or may be left in the three-dimensional shaping apparatus 900. Then, while raising a platform 310, the material of a three-dimensional shaped object 930 such as a resin 380 filled in a vat 320 is irradiated with the laser beam exiting from the two-dimensional MEMS mirror 304, thereby shaping the three-dimensional shaped object 930. The three-dimensional shaping apparatus 900 executes shaping of the three-dimensional shaped object 930 after completion of the measurement of the shape of the object 940.

According to this example embodiment, since it is possible to measure the shape of an object with a simple apparatus arrangement, a three-dimensional shaped object can be shaped simply and quickly. In addition, it is possible to shape an accurate three-dimensional shaped object.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

1. A three-dimensional shaping apparatus comprising:
a light irradiator that performs irradiation with different kinds of a first laser beam and a second laser beam;
a light receiver that receives reflected light of the first laser beam with which an object is irradiated from said light irradiator;
a measurer that measures a shape of the object based on the reflected light; and
a controller that shapes a three-dimensional shaped object by controlling irradiation of a material of the three-dimensional shaped object with the second laser beam by said light irradiator based on the shape of the object measured by said measurer.

2. The apparatus according to claim 1, wherein said light irradiator irradiates the object with an infrared laser beam as the first laser beam.

3. The apparatus according to claim 1, wherein said light irradiator irradiates the object with a visible laser beam as the second laser beam.

4. The apparatus according to claim 1, wherein said light irradiator includes an electromechanical mirror.

5. A control method of a three-dimensional shaping apparatus, comprising:
performing irradiation with different kinds of a first laser beam and a second laser beam;
receiving reflected light of the first laser beam with which an object is irradiated in the performing the irradiation;
measuring a shape of the object based on the reflected light; and
shaping a three-dimensional shaped object by controlling irradiation of a material of the three-dimensional shaped object with the second laser beam in the performing the irradiation based on the shape of the object measured in the measuring.

6. A control program of a three-dimensional shaping apparatus for causing a computer to execute a method, comprising:
performing irradiation with different kinds of a first laser beam and a second laser beam;
receiving reflected light of the first laser beam with which an object is irradiated in the performing the irradiation;
measuring a shape of the object based on the reflected light; and
shaping a three-dimensional shaped object by controlling irradiation of a material of the three-dimensional shaped object with the second laser beam in the performing the irradiation based on the shape of the object measured in the measuring.
